(19) United States
(12) Patent Application Publication
(10) Pub. No.: US 2016/0137046 A1
(43) Pub. Date: May 19, 2016

(54) TRUNK ROOM MOUNTING STRUCTURE OF HYBRID VEHICLE

(71) Applicants: HYUNDAI MOTOR COMPANY, Seoul (KR); Kia Motors Corporation, Seoul (KR)

(72) Inventor: Won Ki SONG, Seoul (KR)

(21) Appl. No.: 14/677,773

(22) Filed: Apr. 2, 2015

(30) Foreign Application Priority Data
Nov. 13, 2014 (KR) 10-2014-0157928

(51) Int. Cl. B60K 1/04; H01M 2/10; B62D 25/08

(52) U.S. Cl. CPC B60K 1/04; B62D 25/087; H01M 2/1083; B60K 2001/0416; Y10S 903/952; H01M 2220/20

(57) ABSTRACT

A trunk room mounting structure of a hybrid vehicle includes: a mounting plate configured to be provided in a trunk room of the hybrid vehicle; a battery frame configured to mount a battery for vehicle on the mounting plate; and a supporting frame configured to be mounted on the mounting plate so as to support the battery frame. When the hybrid vehicle having the battery mounted in the trunk room is collided, a damage occurrence in the trunk room is prevented and damage on a fuel system and the battery is minimized, thereby making it possible to improve safety and salability.

### CROSS-REFERENCE TO RELATED APPLICATION

This application is based on and claims the benefit of priority to Korean Patent Application No. 10-2014-0157928, filed on Nov. 13, 2014 in the Korean Intellectual Property Office, the disclosure of which is incorporated herein in its entirety by reference.

### TECHNICAL FIELD

The present disclosure relates to a trunk room mounting structure of a hybrid vehicle, and more particularly, to a trunk room mounting structure of a hybrid vehicle capable of preventing a damage occurrence of the trunk room of the vehicle at the time of occurrence of collision and counteracting a rear collision.

### BACKGROUND

In general, vehicles such as a hybrid electric vehicle (HEV), a plug-in hybrid electric vehicle (PHEV), an electric vehicle (EV), a fuel cell electric vehicle (FCEV), and the like are mounted with a battery system for driving an electric motor.

Meanwhile, since the battery system has a relatively large size and heavy weight, there are many difficulties in determining a position to which the battery system is mounted in the vehicle.

In addition, in the case in which the battery system is installed in a trunk room of a hybrid vehicle according to the related art, availability of a trunk space is significantly decreased, and in the case in which the battery system is mounted on a position at which a spare tire is mounted, there is safety problem at the time of a rear collision.

### RELATED ART DOCUMENT

Patent Document 1: Korean Patent Laid-Open Publication No. 10-2013-0110386

### SUMMARY

The present disclosure has been made to solve the above-mentioned problems occurring in the prior art while advantages achieved by the prior art are maintained intact.

An aspect of the present disclosure provides a trunk room mounting structure of a hybrid vehicle, and more particularly, a trunk room mounting structure of a hybrid vehicle capable of preventing a damage occurrence of the trunk room of the vehicle at the time of occurrence of collision and counteracting a rear collision.

According to an exemplary embodiment of the present disclosure, a trunk room mounting structure of a hybrid vehicle includes: a mounting plate configured to be provided in a trunk room of the hybrid vehicle; a battery frame configured to mount a battery for vehicle on the mounting plate; and a supporting frame configured to be mounted on the mounting plate so as to support the battery frame.

The supporting frame may include: side members provided to both ends so as to connect a vehicle body of the hybrid vehicle and the trunk room to each other; a plurality of horizontal members connecting the side members to each other; and a plurality of vertical members connecting the plurality of horizontal members.

The horizontal member and the vertical member may be bent along the trunk room so as to form a battery protection space.

The battery protection space may allow a space to be secured in a rear of the battery at the time of the mounting of the battery.

The battery protection space may distribute load through shape modification at the time of a collision occurrence.

The side members, the horizontal members, and the vertical members may be connected by welding.

The vehicle body and the battery may be connected by bolts and nuts.

### BRIEF DESCRIPTION OF THE DRAWINGS

The above and other objects, features and advantages of the present disclosure will be more apparent from the following detailed description taken in conjunction with the accompanying drawings.

FIG. 1 is a side view showing a trunk room of a trunk room mounting structure of a hybrid vehicle according to the present disclosure.

FIG. 2 is a view showing a rear collision situation of the trunk room mounting structure of the hybrid vehicle according to the present disclosure.

FIG. 3 is a cross-sectional side view showing the trunk room mounting structure of the hybrid vehicle according to the present disclosure.

FIG. 4 is a plan view showing a supporting frame of the trunk room mounting structure of the hybrid vehicle according to the present disclosure.

FIG. 5 is a cross-sectional side view showing a battery fastened state of the trunk room mounting structure of the hybrid vehicle according to the present disclosure.

FIG. 6 is a prospective view showing a supporting frame of the trunk room mounting structure of the hybrid vehicle according to the present disclosure.

FIG. 7 is a cross-sectional side view showing connectivity in a horizontal direction of the trunk room mounting structure of the hybrid vehicle according to the present disclosure.

FIG. 8 is a cross-sectional side view showing connectivity in a vertical direction of the trunk room mounting structure of the hybrid vehicle according to the present disclosure.

FIG. 9 is a view showing a first operation of a load pass of the trunk room mounting structure of the hybrid vehicle according to the present disclosure.

FIG. 10 is a view showing a second operation of the load pass of the trunk room mounting structure of the hybrid vehicle according to the present disclosure.

FIG. 11 is a view showing a third operation of the load pass of the trunk room mounting structure of the hybrid vehicle according to the present disclosure.

FIG. 12 is a side view showing a fourth operation of the load pass of the trunk room mounting structure of the hybrid vehicle according to the present disclosure.

FIG. 13 is a view showing a fifth operation of the load pass of the trunk room mounting structure of the hybrid vehicle according to the present disclosure.

### DETAILED DESCRIPTION

Exemplary embodiments of the present disclosure will be described in detail with reference to the accompanying drawings.

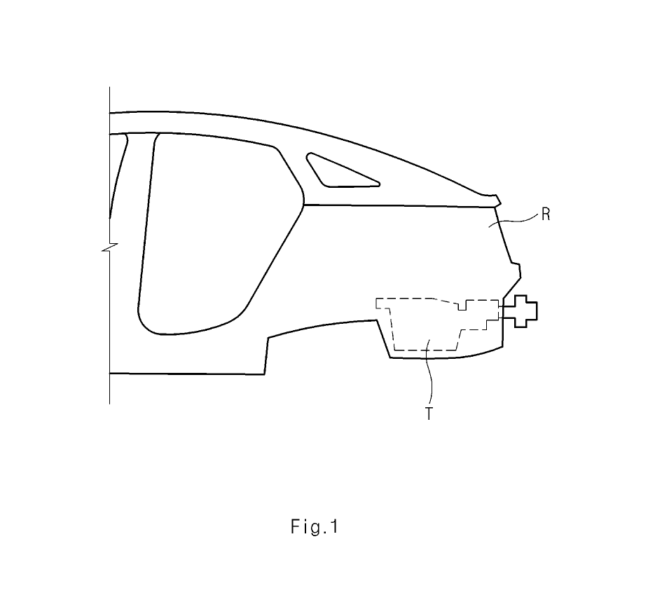

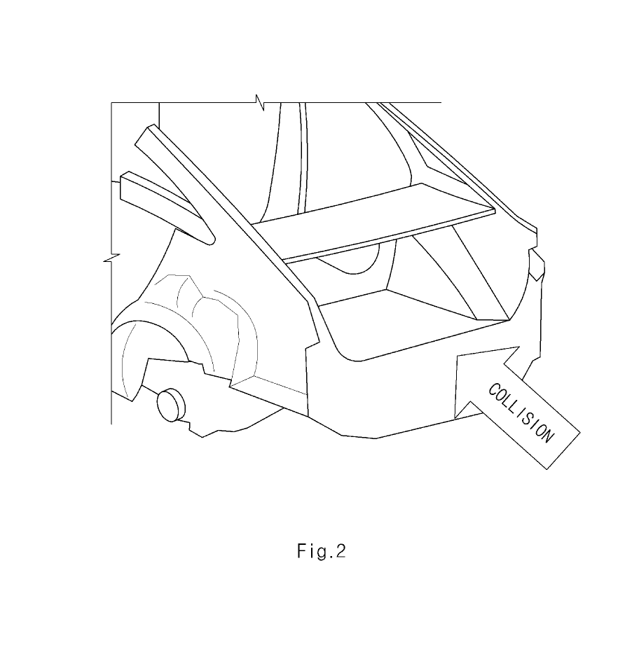

A trunk room mounting structure of a hybrid vehicle according to the present disclosure includes a mounting plate 100 provided in a trunk room R, a battery frame 200 for mounting a battery, and a supporting frame 300 for supporting the battery frame 200, as shown in FIGS. 1 to 5.

As shown in FIGS. 1 to 3, the mounting plate 100 is provided below the trunk room R of the hybrid vehicle.

In this case, a rear of the mounting plate 100 may be formed to be bent so that the trunk room R is provided therein.

Meanwhile, since the present disclosure relates to the hybrid vehicle, a battery for driving an electric motor is basically provided in the trunk room R.

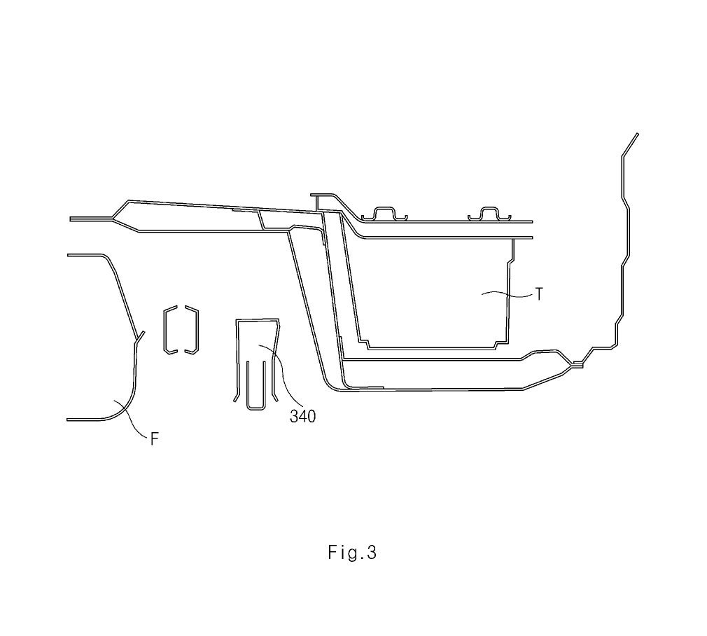

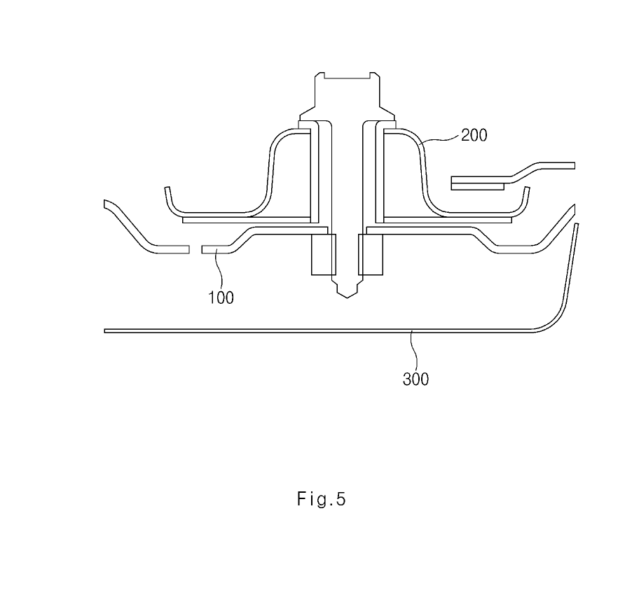

As shown in FIGS. 3 and 5, the battery frame 200 is provided on the mounting plate 100 so as to fixedly mount the battery on the mounting plate 100.

As shown in FIGS. 3 to 5, the supporting frame 300 is mounted below the mounting plate 100 so as to support the mounting plate 100 and the battery frame 200.

In this case, the supporting frame 300 includes a side member 310, a horizontal member 320, and a vertical member 330.

The side members 310 are provided to both ends in front and back directions so as to connect a vehicle body of the hybrid vehicle and the trunk room R to each other.

A plurality of horizontal members 320 are provided in a horizontal direction so as to connect the side members 310 of both ends to each other.

A plurality of vertical members 330 are provided in the front and back directions so as to connect the plurality of horizontal members 320 to each other.

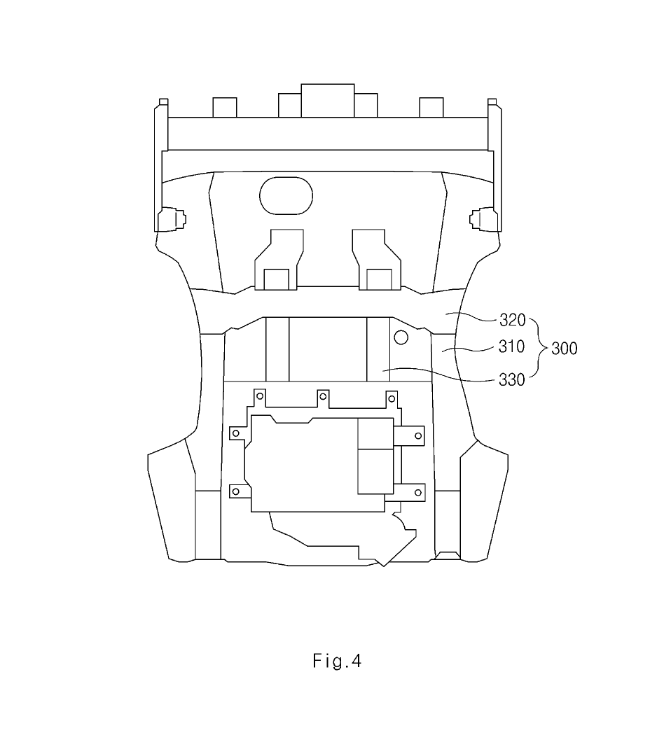

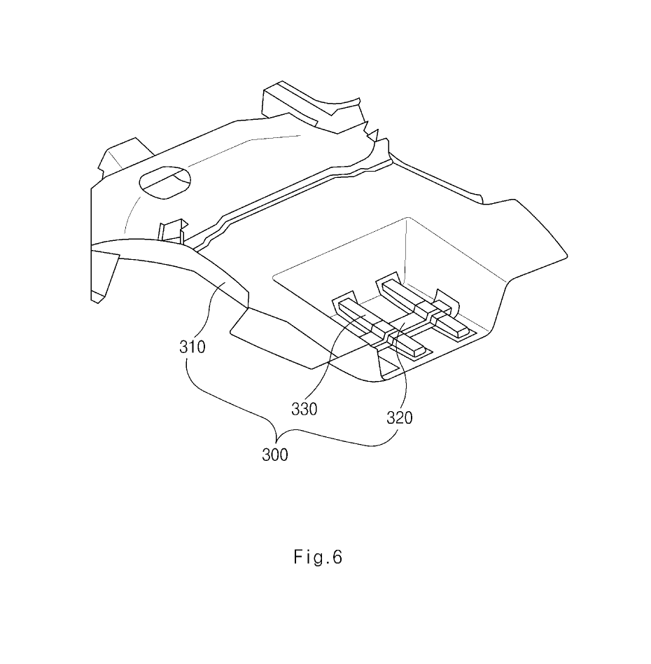

As shown in FIGS. 4 and 6, the plurality of horizontal members 320 and the plurality of vertical members 330 may be connected to each other so as to form a lattice structure.

In addition, the horizontal members 320 and the vertical members 330 may be bent along the trunk room R so as to form a battery protection space T in order to protect the battery mounted in the trunk room R at the time of an occurrence of a rear collision.

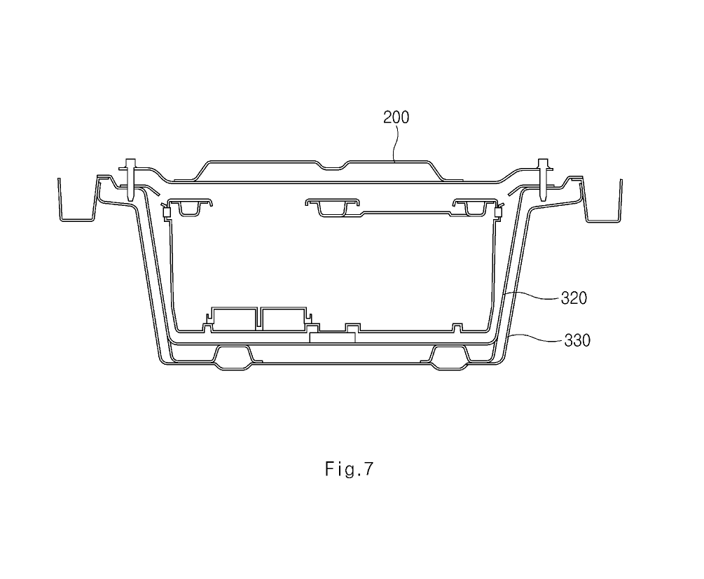

Meanwhile, as shown in FIGS. 7 to 9, the battery frame 200 is formed in a lattice structure.

In this case, the battery protection space T allows a space to be secured in a rear of the battery by the battery frame 200 and the supporting frame 300 even after the batter is mounted, thereby making it possible to maximize battery protection performance.

In addition, the battery protection space T may modify a shape of the supporting frame 300 at the time of the collision occurrence so as to distribute load through the shape modification of the supporting frame 300.

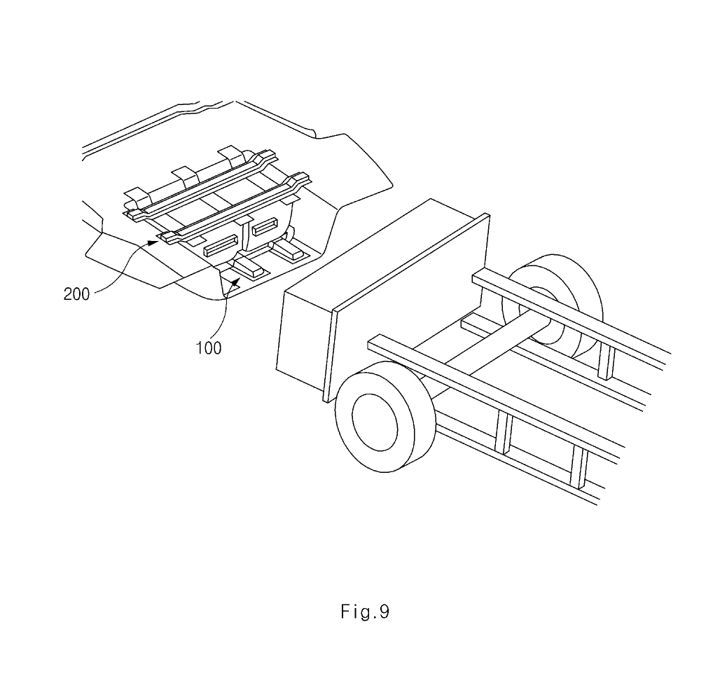

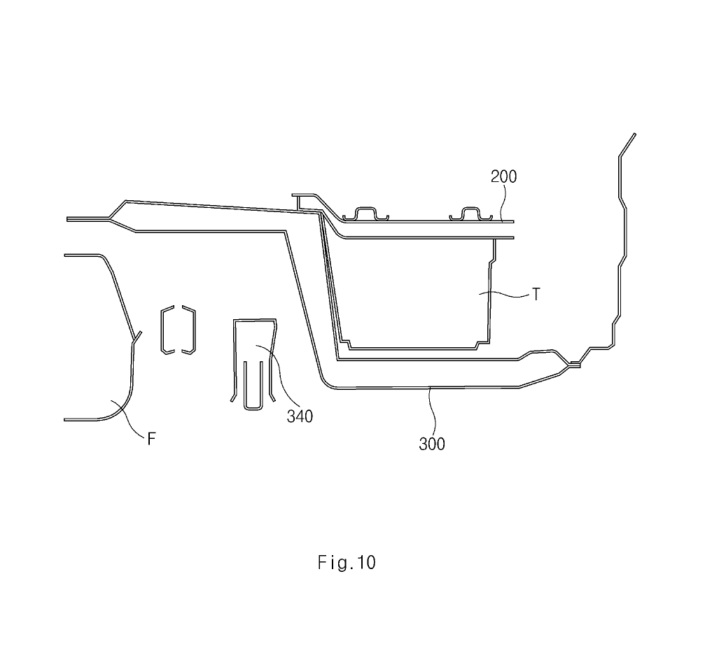

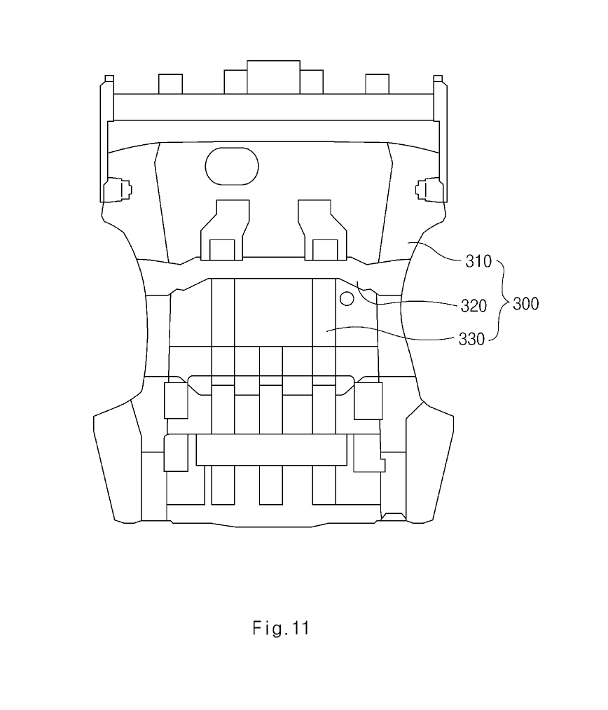

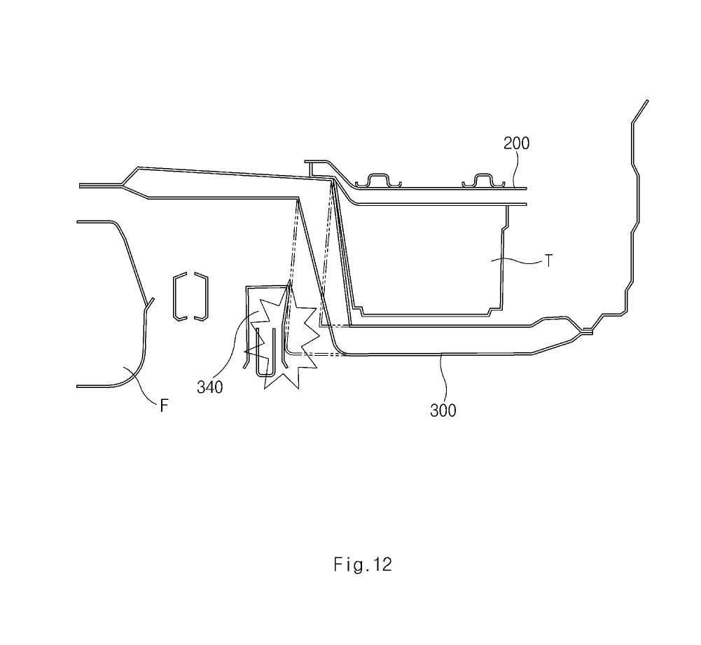

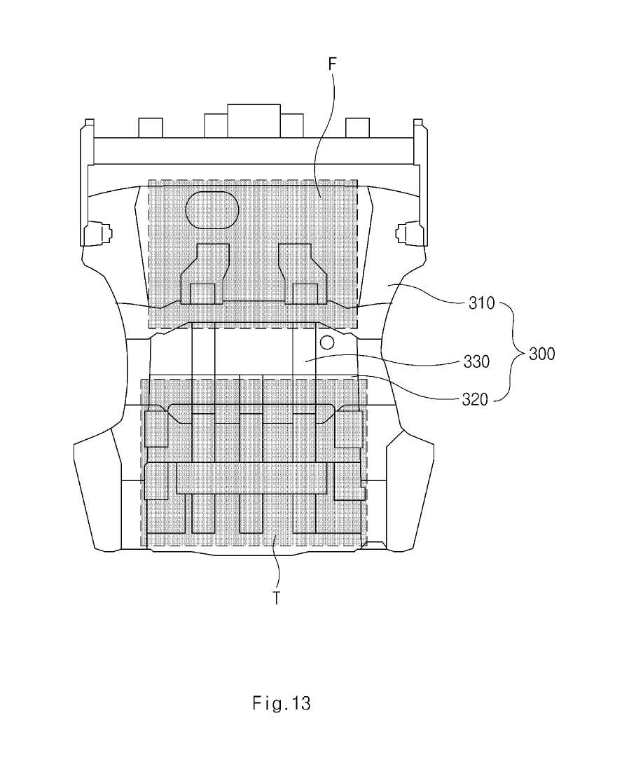

That is, according to the present disclosure, firstly, when a collision object and the supporting frame 300 collide with each other at the time of the occurrence of the rear collision as shown in FIG. 9, secondly, a direct contact with the battery is prevented by the battery protection space T and the battery space is protected as shown in FIG. 10, thirdly, the collision load is distributed by the mounting plate and the supporting frame 300 as shown in FIG. 11, fourthly, the horizontal member 320 and the vertical member 330 of the supporting frame 300 are modified to be in contact with a subframe so as to distribute the collision load again and dissipate collision energy generated at the time of the collision as shown in FIG. 12, and fifthly, the load is distributed through the lattice structure of the supporting frame 300 so as to also protect a fuel tank F as shown in FIG. 13.

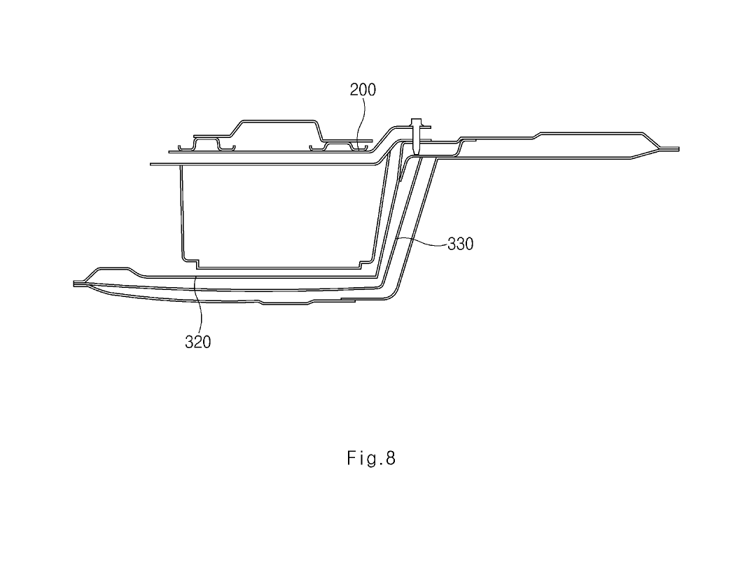

Meanwhile, the side member 310, the horizontal member 320, and the vertical member 330 are connected by welding and the vehicle body and the battery are connected through bolts and nuts, such that connectivity in the horizontal direction of the vehicle body and the battery frame 200 is improved as shown in FIG. 7, and the vehicle body and the subframe are in contact with each other so as to prevent the battery from being pushed, thereby improving connectivity in the vertical direction as shown in FIG. 8.

As described above, according to the present disclosure, the mounting plate 100 provided in the trunk room R of the hybrid vehicle, the battery frame 200 for mounting the battery for vehicle on the mounting plate 100, and the supporting frame 300 mounted on the mounting plate 100 so as to support the battery frame 200 are provided, such that when the hybrid vehicle having the battery mounted in the trunk room R is collided, a damage occurrence in the trunk room R is prevented and damage on a fuel system and the battery is minimized, thereby making it possible to improve safety and salability.

As described above, according to the exemplary embodiments of the present disclosure, the damage occurrence may be prevented at the time of the occurrence of the collision of the hybrid vehicle having the battery mounted in the trunk room and damage on the fuel system and the battery may be minimized, whereby safety and salability may be improved.

As described above, although the present disclosure has been described with reference to exemplary embodiments and the accompanying drawings, it would be appreciated by those skilled in the art that the present disclosure is not limited thereto but various modifications and alterations might be made without departing from the scope defined in the following claims.

What is claimed is:

1. A trunk room mounting structure of a hybrid vehicle, the trunk room mounting structure comprising:
a mounting plate provided in a trunk room of the hybrid vehicle;
a battery frame for mounting a battery for the hybrid vehicle on the mounting plate; and
a supporting frame mounted on the mounting plate so as to support the battery frame.

2. The trunk room mounting structure according to claim 1, wherein the supporting frame includes:
side members having opposite ends connecting a vehicle body of the hybrid vehicle and the trunk room to each other;
a plurality of horizontal members connecting the side members to each other; and
a plurality of vertical members connecting the plurality of horizontal members.

3. The trunk room mounting structure according to claim 2, wherein the horizontal member and the vertical member are bent along the trunk room so as to form a battery protection space.

4. The trunk room mounting structure according to claim 3, wherein the battery protection space allows a space to be secured in a rear of the battery at the time of the mounting of the battery.

5. The trunk room mounting structure according to claim 4, wherein the battery protection space distributes load through shape modification at the time of a collision occurrence.

6. The trunk room mounting structure according to claim 2, wherein the side members, the horizontal members, and the vertical members are connected by welding.

7. The trunk room mounting structure according to claim 2, wherein the vehicle body and the battery are connected by bolts and nuts.
